(19) United States
(12) Patent Application Publication
(10) Pub. No.: US 2005/0240458 A1
(43) Pub. Date: Oct. 27, 2005

(54) Methods and apparatus for transaction and project management

(75) Inventors: John P. Ciacciarelli, Succasunna, NJ (US); Robert Dildine, Greensboro, NC (US); Martin Gerald Ives, Warren, NJ (US); John F. Lertola, Lebanon, NJ (US); Bernard Radomski, East Hanover, NJ (US); Justin Woolcott, Berkeley Heights, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ (US)

(21) Appl. No.: 10/830,624

(22) Filed: Apr. 23, 2004

(51) Int. Cl. G06F 17/60

(52) U.S. Cl. 705/8

(57) ABSTRACT

Systems and techniques for project management and reporting. A specification manager suitably operates in the context of a business management system. The specification manager collects project information useful for constructing a high level overview of a project and creates a project model describing high level functional elements of the project. The specification manager receives detailed information about the project, suitably by periodically querying a database that is continually updated with project information as the project proceeds. The specification manager organizes the information. The information is organized around high level functional elements. The specification manager may report on and manage the project at a more general or a more specific level of detail. The specification manager supports project changes by maintaining links between change orders and the project model, so progress on a change order is automatically tracked and its impact on cost and revenue easily seen.

### FIELD OF THE INVENTION

The present invention relates generally to improved methods and apparatus for management of projects and the tracking and allocation of revenue earned by completion of elements and milestones relating to such projects. More particularly, the invention relates to systems and techniques for a single system for managing projects that can support varying levels of integration between achievements or milestones of a project and the specific actions and deliveries needed to accomplish those achievements or milestones.

### BACKGROUND OF THE INVENTION

The nature of a sale of a product or service may vary widely depending on the complexity of the product or service and the desires of the customer as they relate to the product or service purchased. Particularly in sales of complex products or services, the product or service may be promoted to and regarded by the customer not as a set of components, but as a solution in order to achieve particular customer goals. For example, a customer may see a complex telephone switching system not as a collection of servers, switching units and user interfaces, but rather as a way to achieve a desired level of convenience and efficiency of communication. To the vendor of the switching system, providing the convenience and efficiency of communication needed by the customer involves obtaining and placing the required components and configuring the components so that they operate in such a way as to provide the services needed by the customer. The vendor earns revenue by obtaining, placing and configuring these components. Moreover, the costs incurred by the vendor are the costs of obtaining, placing and configuring the components.

In a complex project, the earning of revenue by the selling entity is an ongoing process, with a portion of the total revenue being earned whenever a predetermined milestone is achieved in the process. Typical prior art techniques express the project in terms of general functional elements, without going into detail about the individual items, such as electronic components, programming and construction, that go into those elements. It is difficult for a reviewer who wants to see the progress of a project to perform a detailed examination of a functional element.

Automated management systems typically manage the project at a relatively high level, providing a reviewer with information about high level functional elements. Automated systems supporting this level of review do not generally provide easy ways to make connections between a high level element and the components comprising the element. If a reviewer wishes to examine a functional element down to a component level, he or she must generally perform a time consuming and difficult inquiry, reviewing records, communicating with personnel responsible for providing the functional element and otherwise gathering information.

It is highly advantageous for vendors to be able to support whatever level of project review is desired. A vendor may wish for its own reasons to be able to tie high level functional elements to the individual components making up those elements, or a customer may wish to receive reports that show each functional element of a project, or the project as a whole, at whatever level of detail is desired.

There exists, therefore, a need for systems and techniques to support management of a project at whatever level of integration is desired and that provide easy and automated ways to follow connections between higher level elements of a project and lower level elements.

### SUMMARY OF THE INVENTION

A system according to an aspect of the present invention includes a specification manager, suitably operating in the context of a business management system. The specification manager suitably receives project information useful for constructing a high level overview of a project and creates a project specification including high level functional elements of the project. The high level overview that is received may suitably comprise project items drawn from information in a sales order created using a business management system. The specification manager then examines detailed information about the project and creates links between the project items and specific project components and activities related to the project items. Each link creates an association between a project item in the project specification, the corresponding project item in the sales order and the specific components and activities related to the project item. The specification manager therefore carries changes in one linked item to each associated linked item. For example, an update to an item in the sales order will cause updates, if appropriate, to the corresponding item in the project specification and in associated information relating to project components and activities. Similarly, an update to information relating to project components and activities will cause updates to affected items in the project specification and in the sales order. The specification manager suitably maintains and updates information by periodically querying a database that is continually updated with project information as the project proceeds.

The specification manager organizes presentation and management of project information. Presentation of information may suitably be organized around high level functional elements, with each element serving as a gateway to greater and greater levels of detail about the element. The specification manager provides the ability to link high level functional information to more detailed information in reporting on and managing the project and allocating costs and revenue, or to maintain reporting and management at a higher level, in which case costs and revenue may be allocated through prorating. The specification manager also supports changes to projects by maintaining links between change orders and the project specification, so that the entry of and progress on a change order is automatically tracked and its impact on cost and revenue is easily seen.

A more complete understanding of the present invention, as well as further features and advantages of the invention, will be apparent from the following Detailed Description and the accompanying drawings.

### BRIEF DESCRIPTION OF THE DRAWINGS

FIG. 1 is a graphical illustration of a project that may suitably be managed according to an aspect of the present invention;

FIG. 2 illustrates a system for project management according to an aspect of the present invention;

FIG. 3 illustrates a business management application that may be used in a system according to an aspect of the present invention;

FIG. 4 illustrates a specification manager according to an aspect of the present invention;

FIGS. 5-7 illustrate displays that may be generated using a specification manager according to an aspect of the present invention; and

FIG. 8 illustrates a process of project management employing the teachings of the present invention.

### DETAILED DESCRIPTION

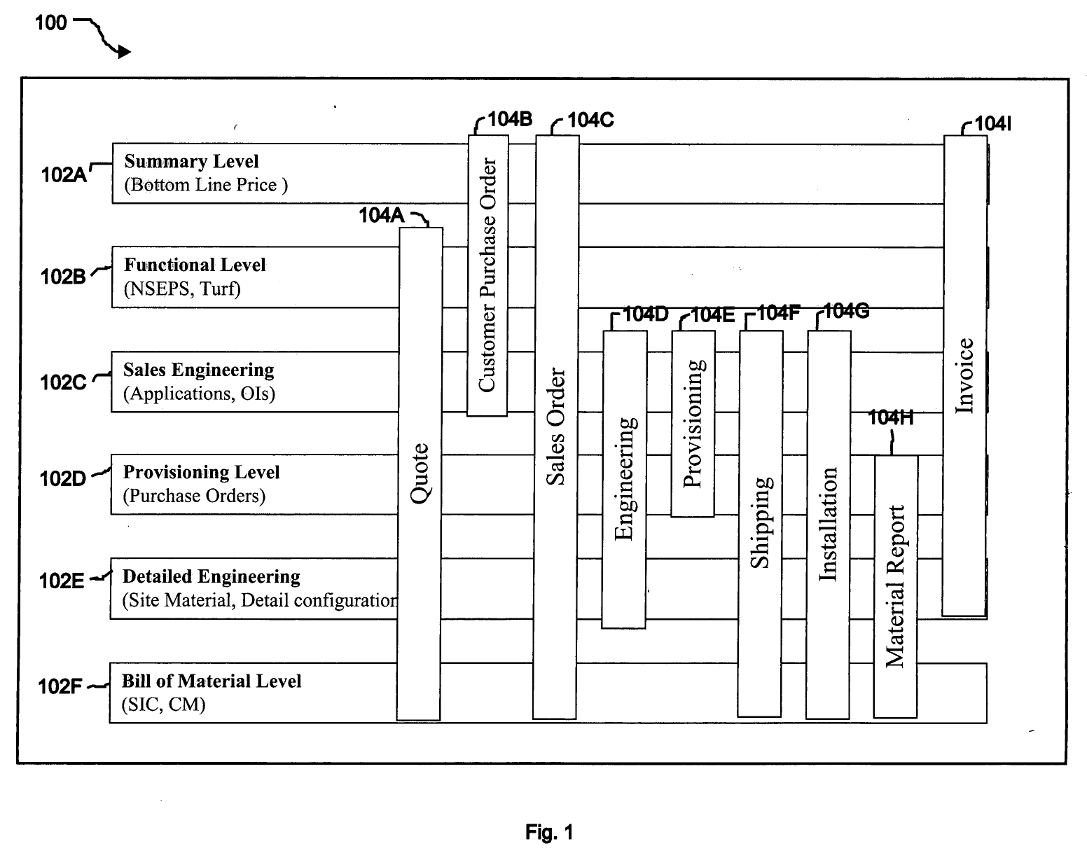

FIG. 1 is a chart 100 illustrating various levels of detail of a project, the types of events that may occur requiring or using information about the project and the levels of detail at which information can be provided with respect to each event. The chart 100 illustrates six levels of detail at which information may be reviewed. These levels include a summary level 102A at which the overall project may be described. A functional level 102B shows major functional elements of the project. A sales engineering level 102C describes the functional elements in additional detail. A provisioning level 102D lists components making up the elements of the project. A detailed engineering level 102E describes the components and their assembly and configuration. A bill of materials level specifies each assembled component of the project, the individual elements of the component and details of the configuration and installation of the component. While six levels of detail 102A-102F are shown and described, it will be recognized that more or fewer levels and different levels may be employed as desired.

The chart 100 further shows events that may occur, expressed in the form of bars 104A-104I, each bar being associated with an event. Each of the bars 104A-104I intersects one or more of the levels 102A-102F. The highest level intersected by one of the bars 104A-104I indicates the highest level of detail of information relating to the event and the lowest level intersected by one of the bars 104A-104I indicates the lowest level of detail of information relating to the event. For example, the bar 104A illustrates the issuing of a quote to a customer and may use information having a level of detail at any one or all of the levels 102B-102F. The bar 104B illustrates the issuing of a sales order by a customer and may use information having a level of detail at any of the levels 102A-102C. The bar 104C illustrates the issuing of a sales order, which may use information at any level of detail. The bar 104D, illustrating engineering, intersects the levels 102C-102E, the bar 104E, illustrating provisioning, intersects the levels 102C and 102D, the bars 104F and 104G, illustrating shipping and installation, respectively, intersect the levels 102C-102F, the bar 104H, illustrating a material report, intersects the levels 102D-102F and the bar 104I, illustrating invoicing, intersects all of the levels 102A-102F.

For each type of reporting event, a reviewer, such as a customer or project manager, is able to describe a project element at any of the levels of detail 102-102F intersected by the bar associated with the reporting event, and to retrieve information related to that element at any desired level intersected by the bar. In addition, orders and changes may be entered with respect to any level and will be tracked at all levels.

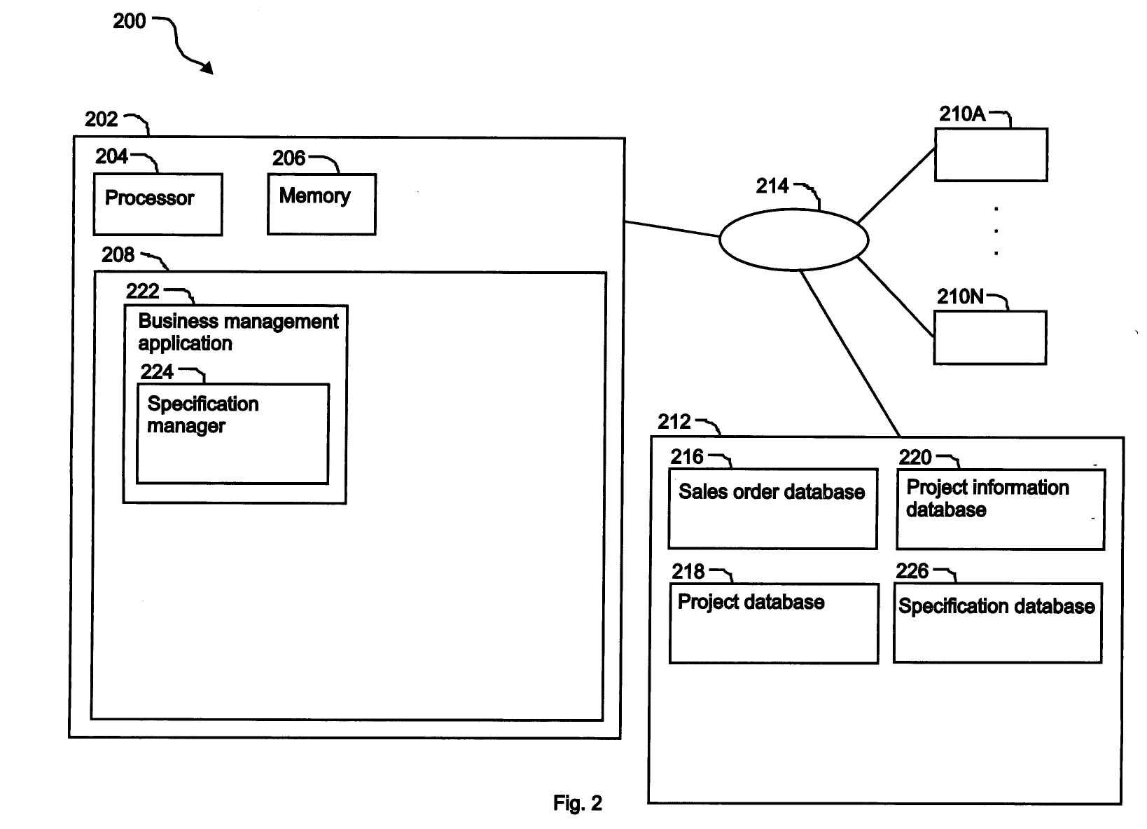

FIG. 2 illustrates a system 200 for project management according to an aspect of the present invention. The system 200 suitably includes a server 202 comprising a processor 204, memory 206 and long term storage 208. The server 202 may communicate with a plurality of user terminals 210A . . . 210N, as well as additional servers or data storage devices such as a server 212, through a local area network 214.

The server 212 hosts information relating to projects to be performed by an organization. Hosted information may suitably include a sales order database 216, including records for the various sales orders generated by the organization, a project database 218 listing projects that have been or are to be performed by the organization and a project information database 220, storing information relating to the various components and activities of each project.

The server 202 suitably hosts a business management application 222, which may be implemented as software residing on the long term storage. The business management application 222 collects information relating to a project of interest, for example from the databases 216-220, formats the information and presents desired information for review. Presentation of information may be performed in response to queries or according to a predetermined schedule.

The business management application 222 includes a specification manager 224. The specification manager 224 constructs a project specification for each project. The project specification includes much of the same information as is present in a sales order, and establishes linkages between sales order items and project components and activities, presents project information in a way that is easily accessible to a user, and allows setting of detail for the review and management of a project. The setting of detail affect the way revenue is earned and managed, for example by determining how costs and revenue are to be allocated to various project components.

In order to create a project specification, the specification manager retrieves the sales order for which the project is to be created from the database 216. The specification manager 224 creates a project specification item corresponding to each sales order item that is to be presented in the project specification. For example, if a sales order is for the construction and installation of a computer network, the sales order may include a sales order item for a print center that is to be part of the network and the specification manager creates a project specification item for the print center, in order to allow tracking and management of information relating to the print center. The sales order will include pricing information relating to sales order items and the overall project, and the project specification will include corresponding pricing information.

Once the specification manager 224 has extracted the relevant information from the sales order to create project specification items, the specification manager 224 begins to query relevant databases, such as the database 220, in order to retrieve information describing the components and services relating to each project specification item. The specification manager 224 creates links between each sales order item, each corresponding project specification item and the stored information relating to components and services contributing to the project item. The links are constructed so that changes to the sales order are reflected in the project specification and vice versa, and also so that project component information influences project specification and sales order items. In addition, the specification manager 224 uses the links to tie sales order items to project components, for example to track the effects of sales order changes on project components and to insure that sales order changes can be made only when the status of the components and services relating to an item to be changed allow for the change. For example, attempted entry of a change to the sales order activates the link to the corresponding project specification item, which in turn activates the link to the related components and services. If the status of the components and services is such that the change cannot be made, the attempted change is not allowed. For example, if assembly of a unit has been completed, a substitution of a different brand of component to be used in the unit is not allowed. A project specification can be thought of as a collection of links, formatted for presentation to a user, and allowing manual or automatic tracking and control of items connected by the links. Suitably, multiple categories of links exist, with the category of a link depending on the level of detail of the information it points to. The information and the links may be organized hierarchically, so that succeeding links point to successively more detailed information, and links at a detailed level can be broken when a project is not to be managed or reported at the level of detail categorizing the link.

Suitably, the specification manager 224 presents the model of a project to a user in the form of a project specification having a format similar to that of a sales order. The project specification includes information similar to that commonly found in a sales order, but typically does not include all the information found in the sales order. For example, the project specification need not include the identity of the customer or similar information not related to the components and management of the project and the revenue generated by the project.

The specification manager 224 allows selection of a level of detail at which a project is to be managed. The levels of detail that are supported in the present example are those illustrated in FIG. 1 and discussed above. These are, as noted above, the summary level, the functional level, the sales engineering level, the provisioning level, the detailed engineering level and the bill of materials level. It will be recognized, however, that the specification manager 224 can be designed so as to accommodate any number of combinations of levels of detail. The specification manager 224 can create or break links between project specification items and project components and activities, depending on the level of detail that has been selected. Suitably, different detail settings can be chosen for different users and activities. For example, the status of a project can be reported at different levels of detail for different users and reporting and management of a project can be carried out at different levels of detail.

Once the project specification has been created, the specification manager 224 continually updates the project specification. Typically, the specification manager 224 examines each database in which project information might reside, for example the project information database 220. Preferably, the specification manager 224 issues queries at relatively short intervals, such as every 15 minutes, in order to maintain an up to specification. Links are created, deleted or revised as a response to addition of new information or changes in existing information. Typically, detailed data for a project becomes available once the project has reached the engineering stage, because it is at the engineering stage that detailed specifications for the project are developed.

Each project specification has access to all details that have so far been received relating to a project, with the functional elements defined and linkages able to be created between a general description of the overall project, descriptions of major elements of a project, detailed descriptions of the components that make up each elements, and so on. Each project specification typically has access to whatever cost and scheduling information, either planned or actual, has been received up that that point, as well as all other information, such as delivery, configuration and cost information that is available.

The specification manager 224 may suitably be designed so as to operate within the context of the business management application 222, receiving queries routed through the application 222 and delivering information in a format usable by the application 222. The business management application 222 may suitably be a standard product with which the specification manager 224 is adapted for use. One family of business management applications with which the specification manager 224 may advantageously be used is the family of business suites produced and marketed by SAP. These business suites provide high level views of sales, revenue and project management and can advantageously use the information provided by the specification manager 224.

The specification manager 224 allows for presentation and management of a project at a specified level of detail. For example, if a general level of detail is specified, the project specification may present project items in terms of high level functional elements, and reporting of a project may be performed in such terms. In such a case, revenue allocation for project components may be accomplished through prorating of the components in accordance with an overall price for the project. In many cases, it may be necessary for pricing or revenue to be allocated to each component of a project, even if the project is not managed at a detailed level. In many such cases, each component has a standard list price, with the total list prices of components adding up to more than the overall price for the project. In order to obtain a proper allocation of pricing and revenue to components, the overall project price may be prorated among components in proportion to the list prices of components.

Alternatively, it is possible to present the project specification at a general level but to manage the project at a more detailed level. In this case, the project specification presents the project items in terms of functional components as before, but every component of the project is linked to a corresponding project specification item, and cost and revenue information attributable to a project specification item is generated through a detailed analysis of the components linked to that item. Completion of project activities and milestones related to project items, and allocation of revenue to the various project items, is accomplished through a detailed analysis of each activity related to an item.

To take an example, if the project is the installation of a small computer network, the levels of detail may include:
The network as a whole;
The functional capabilities provided by the network, such as file management, print management, and so on;
A general overview of the functional elements going to provide the functional capabilities, with links between each functional capability and the functional elements going to provide that capability, such as file management centers, print management centers, network interfaces, and so on;
Detailed descriptions and lists of the individual components going into each functional element, such as file servers, print servers, network interfaces, network cards, operating software, and so on, with links between each functional element and the components that go to make it up;
Complete descriptions of the design of each functional element, including comprehensive lists of components and configuration plans, with each description of an element being linked to that element;
Complete descriptions of the design of each component, along with details of its delivery and installation, with all details for an element being linked to that element. Information provided at each level of detail includes timetable and cost information.

A reviewer can begin an examination of the project at any level desired, and can specify the level of detail to be received. In addition, the specification manager 224 can be designed or programmed so that the information provided in response to any reporting event, such as the events 104A-104I of FIG. 1, provides information at a specified level of detail for that reporting event.

The specification manager 224 allows a convenient user interface for each project, and allows the user to examine a project at any supported level of detail. When a user wishes to examine a project, he or she suitably provides a project identifier to the specification manager 224. The specification manager 224 retrieves the project specification for the identified project from a specification database 226, and presents the project to the user. Suitably, the information in the specification is presented at the most general level of detail. When the user selects an element presented at the most general level of detail, the specification manager 224 then presents links to all the levels of detail for that item that are specified for that user. For example, a customer may wish to receive information at the functional level or the sales engineering level, so information is made available to the customer at those levels. Suitably, the specification manager 224 provides an interface allowing changes in the level of detail that is accessible, so that a user can increase or decrease the level of detail to be presented.

In addition, the specification manager 224 may be programmed to produce reports for various users, either at specified time intervals or on the occurrence of a specified event such as one of the reporting events 104A-104I of FIG. 1. The report is suitably presented in a format similar to that of a sales order, with an overview presented at a general level of detail, with additional detail presented for each general element, down to the specified maximum level of detail to be presented to the user for whom the report is being prepared. The specification manager 224 may provide additional information, for example information for use in managing a project and analyzing costs incurred and revenue earned, along with costs and revenue to be allocated to the various elements of the project. This information may suitably include a listing of activities and milestones accomplished, with costs and revenue attributed to each activity and milestone. In addition, revenue and costs attributed to each project element may be listed, with allocation of revenue and costs accomplished by detailed examination or by prorating the overall cost of the project among the project elements, depending on the level of detail selected.

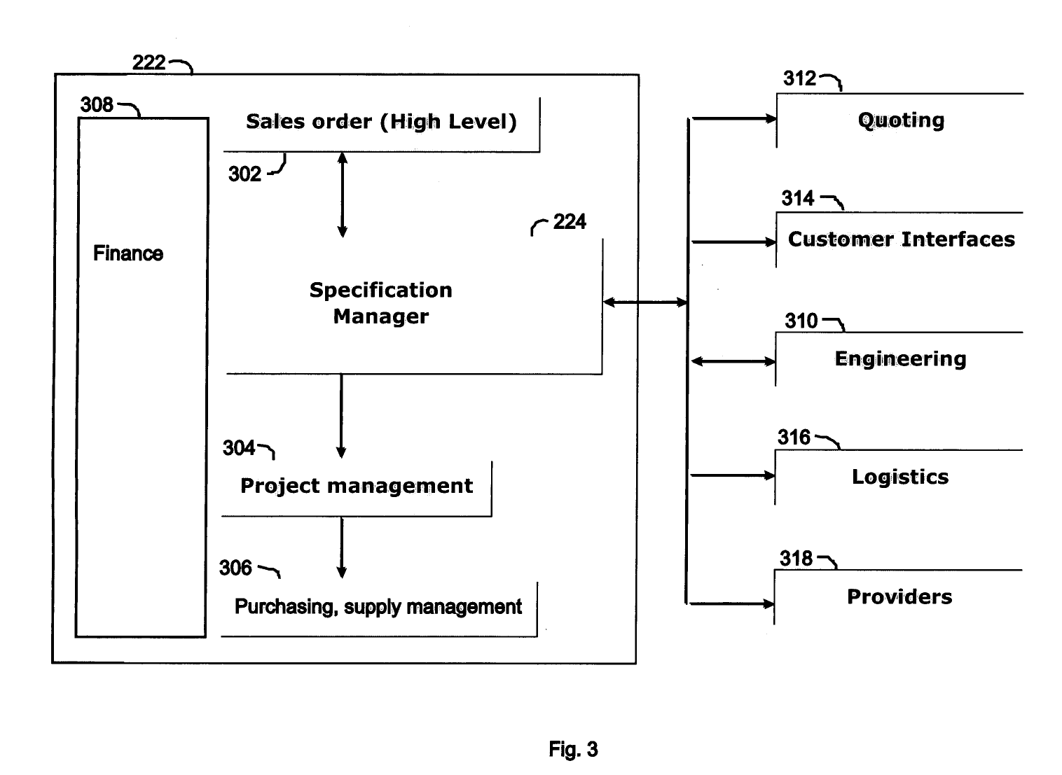

FIG. 3 illustrates the business management application 222 in additional detail. The business management application 222 includes a sales order module 302, the specification manager 224, a project management module 304 and a purchasing and supply management module 306. The business management application 222 further includes a finance module 308. The sales order module, the project management module 304, the purchasing and supply management module 306 and the finance module 308 may all be standard elements, such as elements of a business management suite provided by a vendor such as SAP. The business management application 222 allows entry of and access to information such as sales orders, procurement information, timetable and milestone information and other relevant business information. This information may be entered and accessed using the various modules 302, 304, 306 and 308. It will be recognized that different or additional modules may be included as part of the business management application 222, in order to manage information as desired.

The specification manager 224 provides a high degree of control and management of information, and allows information to be automatically updated in response to changes to related information. As noted above, the specification manager 224 constructs and maintains project specifications, with the specifications comprising links between sales order information and project information. The specification manager 224 automatically tracks updates to information such as sales order information and project information. The specification manager 224 will detect an update to a sales order, update a related project specification and update linked project information. Conversely, an update to project information will cause updating of a related project specification and a related sales order.

The specification manager 224 suitably retrieves a developed sales order from the database 216, and uses the sales order as a framework for constructing the project specification associated with the sales order. The specification manager 224 provides information to the project management module 304 and the finance module 308. The project management module 304 provides information to the purchasing and supply management module 306.

The specification manager 224 provides an interface with various activities in an organization. As noted above, the specification manager 224 receives information from engineering activities 310, for example from a database such as the database 220 or through direct data entry. The specification manager 224 also supplies information to engineering activities 310, for example by updating the database 220, or by providing information automatically or in response to queries to persons working in engineering activities 310. The specification manager 224 provides information to a pricing analysis and quote department 312, and provides information to customers through customer interfaces 314. The specification manager 224 also supplies information to logistics management 316 and may also supply information directly to providers and vendors 318. This information suitably includes information required to properly manage procurement, assembly and delivery of products, and may include information indicating the source of components, particularly if the source is the customer or a vendor having special status, such as a minority owned vendor which such status is relevant to the contract under which the project is being undertaken. Other information may include information relevant to import and export requirements, taxes, local and international shipping and financing, and other relevant information, such as scheduling information. The information is organized according to the structure provided by the sales order, although it will be recognized that numerous other additional ways of organizing the information are possible.

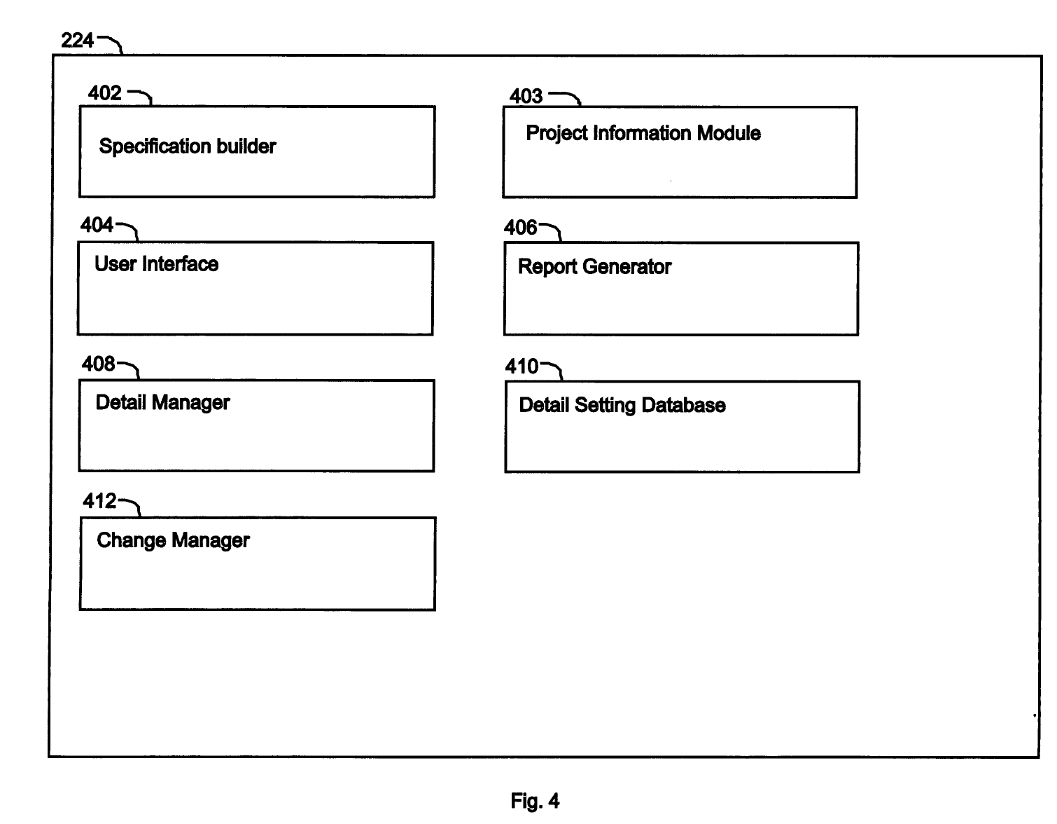

FIG. 4 illustrates additional details of the specification manager 224. The specification manager 224 includes a specification builder 402 for extracting project items from a project description such as a sales order and creating a project specification based on extracted information. The project specification suitably comprises project specification items, with the project specification suitably taking the form of links to corresponding items in the sales order and to related project information.

The specification manager 224 also includes a project information module 403, for receiving the project specification items from the specification builder 402, identifying related project information and constructing links between the project specification items, corresponding sales order items and corresponding project information. The links insure that an update of one item of information will cause updates to corresponding items of related information.

The specification manager 224 further includes a user interface 404, a report generator 406 and a detail manager 408. The detail manager 408 allows setting and management the level of detail at which information is reported or displayed. The specification manager 224 suitably maintains a detail setting database 410, for storage of detail preferences of specified users and detail settings for reports and other information distribution.

The specification manager 224 also includes a linked information manager 411. For each project specification, the linked information manager 411 periodically interrogates information repositories storing information associated with the links included in the project specification, and updates and reconciles related information. For example, the specification manager 224 has access to the sales order database 216 and the project information database 220 of FIG. 2. The linked information manager 411 can retrieve sales orders from the database 216, review sales order items associated with a project specification and update related project information if a sales order item has been changed, for example by updating relevant records in the database 220. For example, if a sales order has been changed to specify a particular brand for a project component, the specification manager updates the associated project information to restrict selections to the specified brand. In addition, the specification manager 224 periodically reviews project information associated with a project specification and updates the project specification and, if applicable, the sales order, to reflect updates to the project information. Updates may include, for example, new information relating to project components, added as the project progresses. Other updates may include the completion of project activities. Large projects are frequently billed in stages, with billing being triggered by the completion of a predetermined project milestone. Project milestones are frequently associated with the completion of a set of project activities. As a project activity is completed, project information may be updated to indicate the completion of the activity, for example by entering completion of the activity in the project information database 220. A project specification typically designates project milestones, with each project milestone designation including links to the project activities required for completion of the milestone. Project milestones are also typically reflected in a sales order, with a project specification including links to project milestones in the associated sales order. The specification manager 224 continually makes queries to update project information and recognizes when a milestone is completed. Completion of a milestone causes an updating of a sales order, and the information is also passed to the finance module 308 of FIG. 3 to allow generation of invoices.

The detail manager 408 receives information from the project information module 403 and controls the presentation and use of the information according to the detail settings that have been established for each particular use of the information. For example, if a particular user wishes to retrieve project specification information, the detail manager 408 retrieves the project specification and presents the project specification employing the user interface 404, using the detail settings for the user to define the information to be presented. If a user wishes the information to be presented in more or less detail, the user may specify different detail settings, for example making selections provided by the user interface 404, which then supplies the selection information to the detail manager 408. Similarly, if a report is to be issued, the detail manager provides information to the report generator 406, controlling the level of detail supplied according to the detail settings for the report to be generated.

The detail manager 408 also uses the detail settings to control the allocation of costs and revenue. If detail settings are at a general level, costs and revenue are prorated among functional elements. If detail settings are at a more detailed level, costs and revenue are managed by detailed analysis of the costs and revenue related to each component. For example, if the project under examination is the installation of a small computer network, allocation of costs and revenue to the installation of a print station may be determined simply by prorating the overall cost of the project to the print station based on the sum of the list prices of the components of the print station. This course will be taken if the detail settings are at a more general level. Alternatively, if the detail settings are at a more detailed level, cost and revenue information related to individual components, such as printers, print servers and the like is used to perform a detailed computation of costs and revenue.

The specification manager 224 also includes a change manager 412, to control and track changes to the project. When a change is initiated, suitably by submission of a change order, the change manager 412 examines the change order and compares the change order information to the project specification. In particular, the change manager 412 identifies the components to which changes are to be made and determines whether or not those components have already been completed and shipped. This result is accomplished by examining the timetable information associated with the identified components and rejecting the change order if the timetable shows that it is too late for a change to be made. In addition, the change manager 412 is able to set flags, such as an item “hold” flag or a billing “hold” flag, in order to prevent shipment or billing until a change order has been addressed. In addition, the change manager 412 makes all necessary changes to the project specification, at all levels of detail, resulting from the change, and makes all necessary cost and billing adjustments resulting from the change. For example, the change manager 412 may update purchase orders and purchase requisitions in order to procure the necessary materials, and make necessary updates to installation instructions. The change manager 412 also updates financial information to reflect the change, and the updated financial information is reported according to previously or subsequently set levels of detail, as noted above.

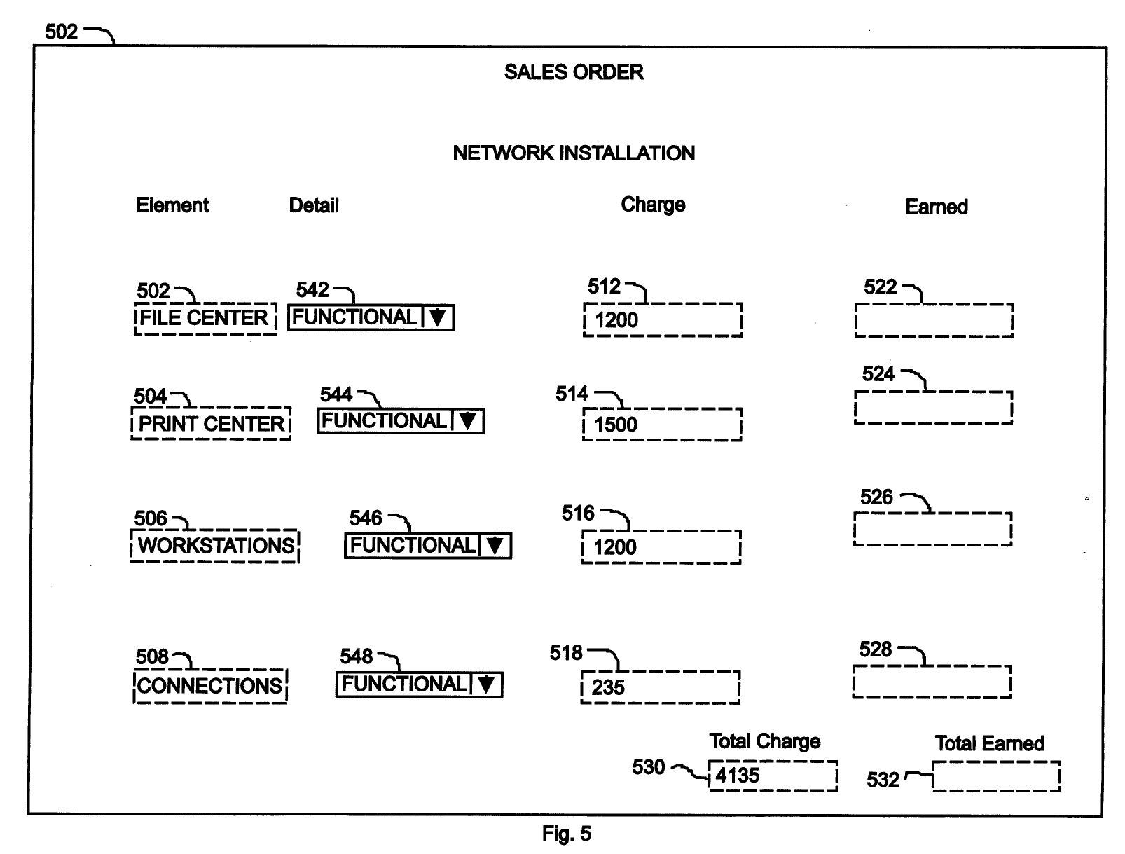

FIGS. 5-7 illustrate various displays that may suitably be generated using the system 100 of FIG. 1. The displays relate to the management of the installation of a small computer network comprising the following components:

| Component | Quantity | Cost per unit | Charge per unit |
|---|---|---|---|
| File server | 1 | $800 | $1200 |
| Print server | 1 | $400 | $600 |
| Printers | 3 | $200 | $300 |
| Network router | 1 | $50 | $75 |
| Workstations | 4 | $200 | $300 |
| Cables | 8 | $15 | $20 |

FIG. 5 illustrates a display 500, used to provide a high level overview of the project whose components are listed above. The display 500 suitably includes fields 502-508, with each field listing a high level element of the project. In this case, the fields 502-508 include listings of a file center, a print center, workstations and connections, respectively. The fields 512-518 list the charge for each element, and the fields 522-528 list the revenue earned so far for each element, while the fields 530 and 532 list the total charge and the total revenue earned, respectively.

The fields 502-508 are accompanied by detail selectors 542-548, respectively. Each of the detail selectors 542-548 sets the level of detail at which the accompanying element is to be reported and managed. At the point illustrated in FIG. 5, no work has yet occurred and no revenue has yet been earned. All of the detail selectors 542-548 are set to a “Functional” level of detail, directing display and management of the project in terms of high level elements.

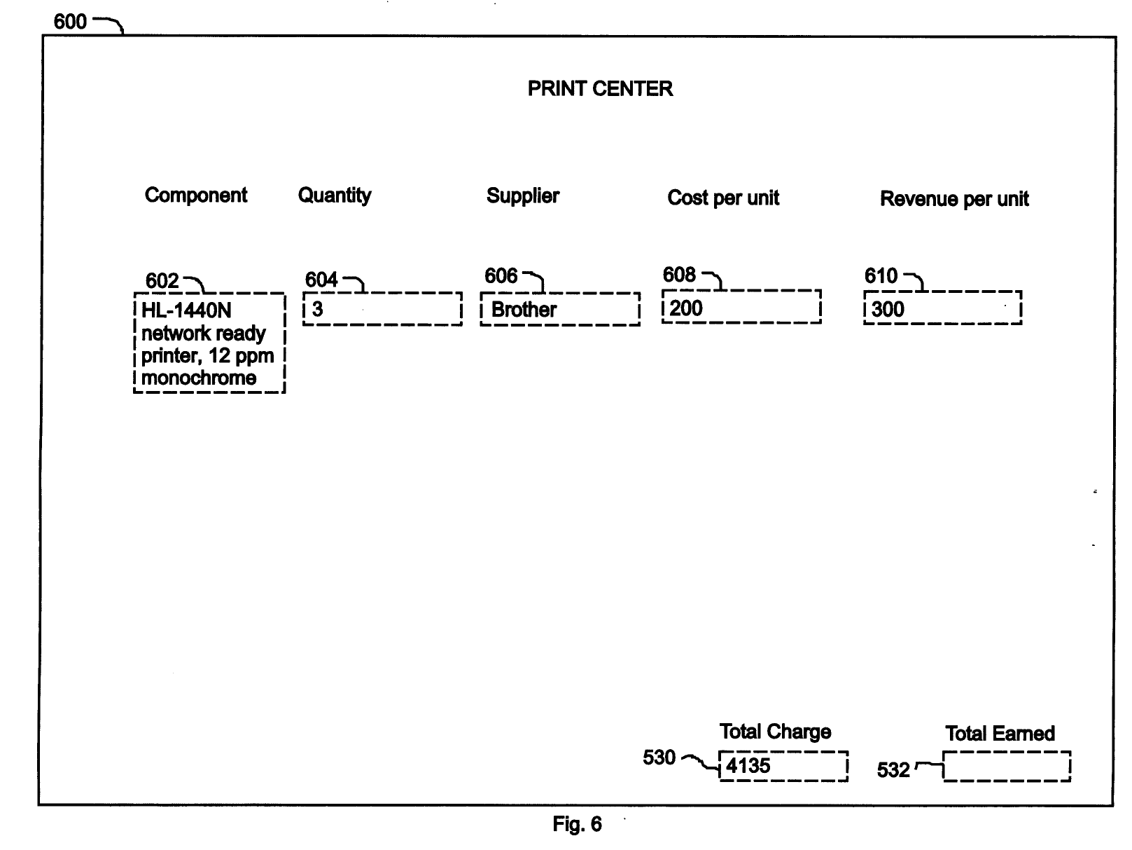

FIG. 6 illustrates a display 600, presented when the detail selector 544 has been set to the “Detailed Engineering” level, and when information relating to the print center has been selected for review. The display 600 shows details of the components of the print center, namely the brand, model, supplier and cost of each printer, as well as configuration details about the installation of the components, timetable information related to the procurement and installation status of each printer, as well as a notation as to whether or not revenue attributed to the printer has been earned. If the project is managed at the “Detailed Engineering” level, cost and revenue allocation will be tightly tied to actual acquisitions and delivery of components. The display 600 includes fields 602-612, showing the component, quantity, supplier, cost per unit and revenue per unit, respectively, as well as fields 614, 616, 618 and 620, showing the scheduled and actual procurement dates and the scheduled and actual installation dates, respectively. The display 600 also includes fields 622 and 624 showing the costs incurred and the revenue earned. The cost and revenue values displayed in the fields 622 and 624 depend on the actual number of units procured and installed. Depending on the setting for the detail with which the overall project is to be managed or reported, the totals shown on a higher level display such as the display 500 may or may not reflect the values shown on a lower level display such as the display 600.

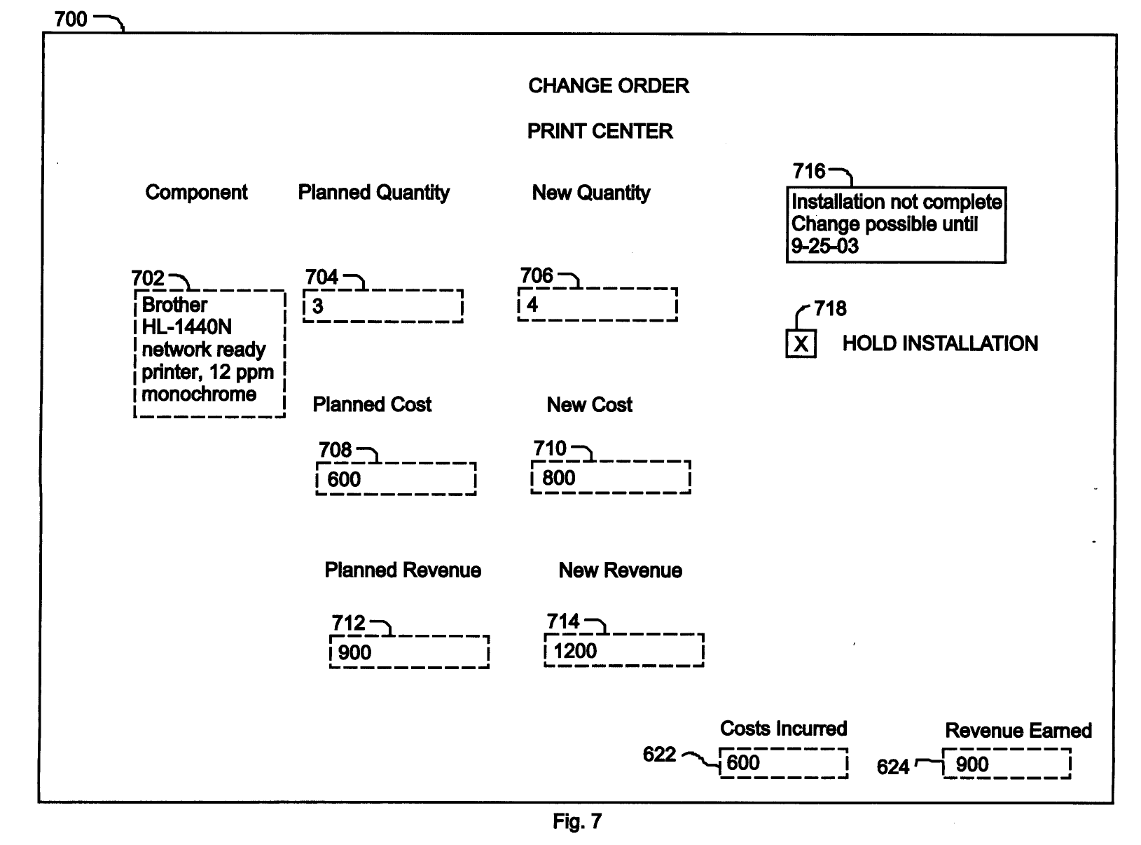

FIG. 7 illustrates a change management display 700, showing a proposed change to the print center plan. Here, the change is the addition of a printer to the planned installation, so that the print center will include four printers and not three. The display 700 includes field 702, showing the component, and fields 704 and 706 showing original and new quantities, as well as fields 708, 710, 712 and 714, for original and new cost amounts and original and new revenue amounts, respectively. The display 700 also includes a field 716 displaying an indication of whether or not installation has occurred, and the last date a change can be entered. The display 718 further includes a “Hold” checkbox 718, allowing a user to enter a “Hold” so that installation will be suspended until the change can be entered.

When information is submitted using the form 700, the model for the associated project is updated, for example by updating a model stored in the database 224. Depending on the detail settings used in managing and reporting the project, the change may or may not be reflected in detail in more general reporting levels. If a high level of detail is chosen, changes, for example, changes to financial totals, will be reflected in detail, while if a lower level is chosen, changes may be reflected by proration to the overall project.

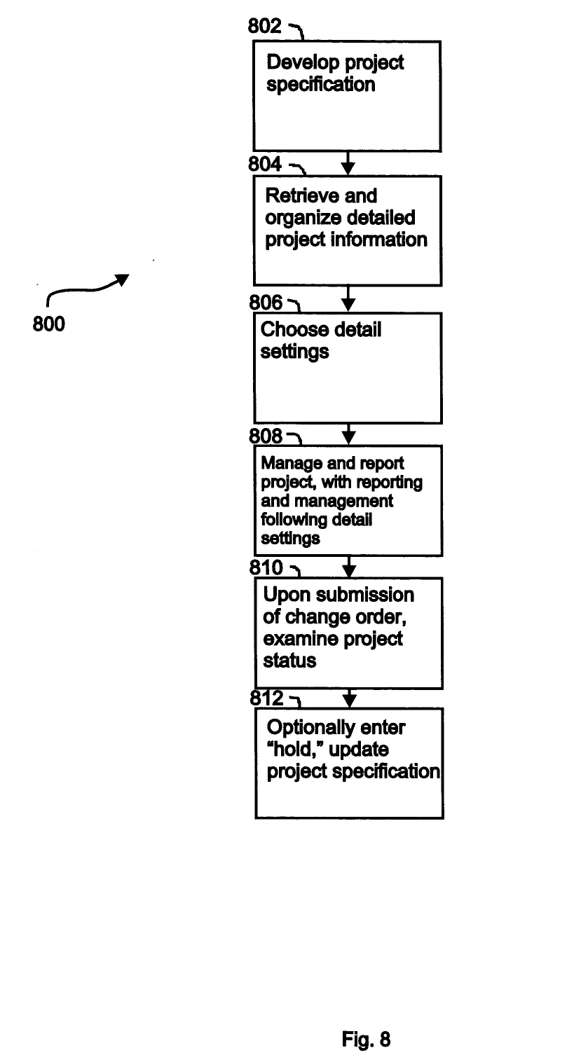

FIG. 8 illustrates the steps of a process 800 of project management according to an aspect of the present invention. The process may suitably be accomplished using a system such as the system 200 of FIG. 2, employing a specification manager such as the specification manager 224 of FIGS. 2, 3 and 4.

At step 802, upon receipt of information a project specification is developed having a structure defined by general project elements. The general project elements may suitably be project specification items corresponding to project items appearing in a sales order, and the project specification items may suitably comprise links between the project items in the sales order and project component and activity information corresponding to the project items in the sales order. At step 804, detailed project component and activity information is periodically received. The project specification is continually updated as updated information becomes available, suitably by querying a project information database and a sales order database at predetermined intervals and updating linked items. At step 806, upon selection of detail settings, the level of detail to be used in managing or reporting the project is defined according to the detail settings. The detail settings may suitably be chosen for each user, management or reporting function and may be changed as desired in order to provide greater or lesser levels of detail. At step 808, reporting and management of the project proceeds, with determination of accomplishment of milestones and allocation of costs and revenue being conducted at selected levels of detail. If high levels of detail are chosen, accomplishment of milestones and allocation of costs and revenue are dependent on procurement, delivery and installation of specific components. On the other hand, if general levels of detail are chosen, accomplishment of milestones and allocation of costs and revenue are defined based on proration of the events under examination to the scope of the overall project.

At step 810, upon submission of a change order, project status is examined to determine if the change order can be executed. If the change order can be executed, the process proceeds to step 812, a “hold” is optionally put on the project element being changed, the project model is updated to reflect and accomplish the necessary changes and financial information reflected in the model is updated as appropriate.

While the present invention is disclosed in the context of a presently preferred embodiment, it will be recognized that a wide variety of implementations may be employed by persons of ordinary skill in the art consistent with the above discussion and the claims which follow below.

1. A project management system, comprising:
a business management application for receiving, storing and formatting information relating to the project and using the project information for project management and review; and
a specification manager for maintaining a project specification including project elements defined at a general level of detail and for retrieving and organizing detailed information relating to each project element, the specification manager being operative to receive detail settings and to report and mange the project at any of a number of specified levels of detail.

2. The system of claim 1, wherein the project elements comprise links between generally defined project items and specific project information relating to the project items and wherein the specification manager is operative to automatically update a linked item in response to updated or additional information for an associated linked item.

3. The system of claim 2, wherein the generally defined project items are stored in a sales order and wherein the project specification maintains links between a sales order and a set of components and activities associated with project items comprising the sales order.

4. The system of claim 3, wherein the specification manager updates project component and activity information in response to updates to corresponding sales order items and updates sales order items in response to updates to corresponding project component and activity information.

5. The system of claim 4, wherein the specification manager periodically retrieves detailed project information relating to project components and activities and updates the project specification whenever updated project information has been retrieved.

6. The system of claim 5, wherein the specification manager monitors project milestones for completion and designates a project milestone as complete when completion of project activities comprising the milestone has been accomplished.

7. The system of claim 6, wherein completion of a project milestone is automatically reported to financial activities for invoicing.

8. The system of claim 7, wherein the specification manager manages price and revenue allocation based on the level of detail that has been selected, with costs and revenue being allocated by apportioning an overall project price among project components and activities based on list prices of the components and activities if a general level of detail has been selected, and allocates costs and revenue by a detailed analysis of costs and pricing attributable to each component and activity if a specific level of detail has been selected.

9. The system of claim 8, wherein the specification manager is operative to receive change information and update the project specification and cost and revenue information according to the change information.

10. The system of claim 9, wherein the specification manager examines sales order items and component and activity information in order to determine if a change is possible before allowing a change order.

11. The system of claim 10, wherein the specification manager blocks a change order if progress on a project item is too far advanced to allow a change to the project item.

12. The system of claim 11, wherein the specification manager allocates cost and revenue changes resulting from the change information according to the selected detail setting.

13. A specification manager for developing and maintaining a project specification for managing and reporting a project, comprising:
a specification builder for creating a specification comprising a set of generally defined project items;
a model information module for collecting component and activity information and associating component and activity information with corresponding project items; and
a detail manager for specifying a level of detail for reporting and managing a project corresponding to the project specification.

14. The specification manager of claim 13, wherein the project specification comprises links between generally defined project items and corresponding project and component activity information.

15. The specification manager of claim 14, further comprising a change manager for receiving project change information, determining whether a change can be allowed and updating the project specification and corresponding project item, component and activity information as a result of the change order and managing billing and revenue information attributable to the change order.

16. A method of project management, comprising the steps of:
developing a project specification according to information relating to general project elements;
receiving and organizing detailed project information according to the structure defined by the project model;
upon receipt of detail settings, defining a level of detail to be used for reporting or managing the project; and
reporting and managing the project, with revenue allocation and reporting of information being governed by the selected detail settings.

17. The method of claim 17, wherein the project specification comprises links between generally defined project items and corresponding project and component activity information.

18. The method of claim 17, further comprising a step of receiving change information related to a project specification, examining the project specification and information related and linked to the project specification to determine if the changes specified by the change information can be allowed and updating the project specification and corresponding project item, component and activity information as a result of the change order and managing billing and revenue information attributable to the change order.
